(19) United States
(12) Patent Application Publication
(10) Pub. No.: US 2022/0364679 A1
(43) Pub. Date: Nov. 17, 2022

(54) Methane Retention System

(71) Applicant: Estis Compression, LLC, Kilgore, TX (US)

(72) Inventor: John Gatlin, Bellaire, TX (US)

(21) Appl. No.: 17/744,948

(22) Filed: May 16, 2022

Related U.S. Application Data
(60) Provisional application No. 63/189,556, filed on May 17, 2021.

(51) Int. Cl. F17C 5/06; F04B 41/02

(52) U.S. Cl. CPC F17C 5/06; F04B 41/02; F17C 2221/033; F17C 2270/01; F17C 2250/07; F17C 2201/054; F04B 2205/16

(57) ABSTRACT

A methane retention system is provided for reducing the amount of natural gas that is vented into the atmosphere during depressurization and maintenance of a natural gas compressor unit. Also provided are a method of depressurizing a natural gas compressor unit and a natural gas system, both of which include the methane retention system.

### BACKGROUND

The present disclosure is directed to a methane retention system that minimizes the amount of natural gas that is vented to the atmosphere when a natural gas compressor is depressurized for maintenance or other reasons.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1A schematically illustrates an embodiment of a methane retention system of the disclosure that is installed for fluid communication with a natural gas compressor unit.

FIG. 1B schematically illustrates another embodiment of a methane retention system of the disclosure.

FIG. 2 is a perspective view of a potential commercial embodiment of a methane retention system installed for fluid communication with a natural gas compressor unit.

FIG. 3 is another perspective view of the apparatus of FIG. 2, taken from a different angle.

### DETAILED DESCRIPTION

The systems, methods, and devices of the present disclosure each have several aspects, no single one of which is solely responsible for its desirable attributes. Without limiting the scope of this disclosure as expressed by the claims that follow, some features will now be discussed briefly. After considering this discussion, and particularly after reading this section, one will understand how the features of this disclosure provide advantages that include reduced venting of greenhouse gases (GHG) from natural gas compressor stations.

In an embodiment of the present disclosure, a methane retention system for receiving, storing, and recycling vented natural gas from a natural gas compressor unit is provided. The methane retention system generally includes: at least one accumulator vessel; at least one recycle line in fluid communication with the accumulator vessel; at least one return line in fluid communication with the accumulator vessel; at least one valve in the recycle line; and at least one valve in the return line; wherein the methane retention system is configured to receive natural gas from the compressor unit, store the natural gas during maintenance of the compressor unit, and return the natural gas to the compressor unit following completion of the maintenance.

In an aspect of the present disclosure, a method of decompressing a compressor unit is provided. The method generally includes: isolating the compressor unit from a source of natural gas; placing an outlet of the compressor unit in fluid communication with at least one accumulator vessel; releasing natural gas from the compressor unit into the at least one accumulator vessel in fluid communication with the compressor unit until a first pressure inside the compressor unit is lowered to a desired second pressure; and isolating the accumulator vessel from the compressor unit to temporarily store the natural gas vented from the compressor unit.

In another embodiment of the present disclosure, a natural gas system is provided. The natural gas system generally includes: a compressor unit; and a methane retention system connected to the compressor unit; wherein the methane retention system is configured to accept and store natural gas from the compressor unit during depressurization of the compressor unit so that less than about 35% of the natural gas in the compressor unit is released into an atmosphere during depressurization of the compressor unit.

When maintenance work is performed on a natural gas compressor that has been in service, the compressor unit must be depressurized to atmospheric pressure in order to enable access to the compressor unit and its components. This has conventionally been accomplished by closing the inlet to the compressor unit, thereby isolating the unit from all upstream flow and pressure, and opening a blowdown valve downstream of the final stage of the compressor unit until the compressor unit has been depressurized to atmospheric pressure. This depressurizing process has involved venting as much as 5000 standard cubic feet (scf) of natural gas into the atmosphere. Natural gas typically contains, in percent by volume, about 70% to nearly 100% methane, about 0-20% propane, and smaller amounts of ethane, butane, carbon dioxide, oxygen, nitrogen and hydrogen sulfide. Methane is the primary component. Natural gas is considered “dry” when it contains almost pure methane, having had most of the other components removed. Natural gas is referred to as “wet” when the other hydrocarbons are still present.

Methane is considered a greenhouse gas that potentially harms the environment. According to the United Nations Economic Commission for Europe, methane in the air can, on a parts per volume basis, warm that air at a rate of 84 times that of carbon dioxide. It is therefore desirable to minimize the amount of natural gas vented into the atmosphere.

The present disclosure is directed to a methane retention system and method for minimizing the amount of natural gas that is vented to the atmosphere during depressurization of a natural gas compressor. The methane retention system includes at least one recycle line adapted for connection downstream of at least one stage of a natural gas compressor. In one embodiment, the recycle line is adapted for connection downstream of a final stage of the natural gas compressor unit. In another embodiment, two or more recycle lines are adapted for connection downstream of two or more stages of the natural gas compressor unit.

The methane retention system also incudes an accumulator vessel connected to the one or more recycle lines. The accumulator vessel accumulates and holds the natural gas that would otherwise be vented into the atmosphere during the depressurization of the natural gas compressor unit. The accumulator vessel can be an appropriately sized steel tank that is designed for holding gas under pressure and is capable of holding natural gas at pressures of up to about 10 atmospheres, or up to about 15 atmospheres, or up to about 20 atmospheres, or up to about 25 atmospheres. One suitable accumulator vessel is a steel tank manufactured by Quality Steel of Cleveland, Miss., which is rated for pressures of up to 250 psig (17 atmospheres). Various sizes are available. In one embodiment, the vessel can have a capacity size (volume) of about 500 gallons (3740 scf). In other embodiments, the accumulator vessel can have a capacity (volume) of at least about 250 gallons (1870 scf), or at least about 500 gallons (3740 scf), or at least about 1000 gallons (7480 scf), or at least about 1500 gallons (11,220 scf) and/or up to about 2000 gallons (14,960 scf).

The methane retention system also includes a return line leading from the accumulator vessel and/or the recycle line and adapted for connection to an inlet line to the natural gas compressor unit. The connection between the recycle line and the inlet line can be located upstream from the natural gas compressor unit. If the natural gas compressor unit has more than one stage, the connection between the recycle line and the inlet line can be located upstream from a first stage of the natural gas compressor unit. The accumulated natural gas is thereby commingled with natural gas from an external source and fed back into the natural gas compressor unit when operations resume.

Using the above-described conventional technique in which the natural gas was vented into the atmosphere, the venting was allowed to continue until the pressure inside the natural gas compressor unit equilibrated with atmospheric pressure. By instead venting the natural gas into the accumulator vessel, the pressure inside the natural gas compressor unit will not equilibrate at atmospheric pressure on its own, but will instead equilibrate at some elevated pressure whereby the pressure inside the accumulator vessel is raised due to the venting and the pressure inside the compressor unit is lowered until both pressures are equal. Without further design or manipulation of the methane retention system, some (albeit a smaller quantity) of the natural gas in the compressor unit will thereafter have to be released into the atmosphere in order to bring the internal compressor pressure down to atmospheric pressure. This is typically accomplished by a) allowing the pressure in the compressor unit to equilibrate with the pressure in the accumulator vessel, then b) isolating the accumulator vessel using a shutoff valve to maintain the pressure in the accumulator vessel, then c) venting the remaining natural gas from the compressor into the atmosphere. Without further design and/or manipulation of the methane retention system, there will still be some natural gas in the compressor that is thereby vented into the atmosphere.

The methane retention system can be designed with one or more additional features to further minimize the amount of natural gas that is vented into the atmosphere. One way is to size the accumulator vessel, and/or include two or more accumulator vessels in the methane retention system, so that the total volume of the accumulator vessel(s) is large relative to the volume in the natural gas compressor unit. For example, the total volume inside the one or more accumulator vessels can be at least about two times the volume inside the compressor unit, or at least about three times, or at least about four times, or at least about five times, or at least about six times, or at least about eight times, or at least about ten times the volume inside the compressor unit. As the volume of the accumulator vessel(s) is increased relative to the volume of the compressor unit, the equilibration pressure between the compressor unit and the accumulator vessel(s) becomes lower and closer to atmospheric pressure, and the amount of natural gas that ultimately needs to be released into the atmosphere from the compressor unit after the accumulator vessel(s) are then isolated is also lowered.

Another way to minimize the amount of natural gas that is ultimately released into the atmosphere is to install a gas compressor or suction pump (e.g., gas pump) in the recycle line between the compressor unit and the accumulator vessel(s). In one embodiment, the gas compressor can include at least one suction compressor. This will allow the gas pressure in the accumulator vessel(s) to be raised to a pressure above what would otherwise be an equilibration pressure, and the pressure in the compressor unit can be correspondingly lowered to atmospheric pressure. The accumulator vessel(s) can then be isolated after all or substantially all of the natural gas from the compressor unit has been transferred to the accumulator vessel(s) and little or no natural gas will then be left in the compressor unit for venting into the atmosphere.

The present disclosure is also directed to a method of depressurizing a natural gas compressor unit. The method can include the step of providing at least one accumulator vessel in fluid communication with a natural gas compressor. The accumulator vessel can include without limitation any of the accumulator vessels described above.

The method can include the step of releasing natural gas from the natural gas compressor unit into the at least one accumulator vessel until a first natural gas pressure in the natural gas compressor is at least reduced to an equilibrium level pressure in the at least one accumulator vessel. Using suitable techniques described above, the first natural gas pressure can be reduced to a pressure that is below the equilibrium level pressure.

The method then includes the steps of isolating the at least one accumulator vessel from the natural gas compressor unit and venting the natural gas compressor unit until the first pressure in the natural gas compressor unit reaches atmospheric pressure. This will enable maintenance to be performed on the natural gas compressor unit without risking an incident due to elevated pressure and/or the mere presence of excessive residual natural gas. Once the maintenance has been completed, the natural gas stored in the at least one accumulator vessel can be released back into the natural gas compressor unit.

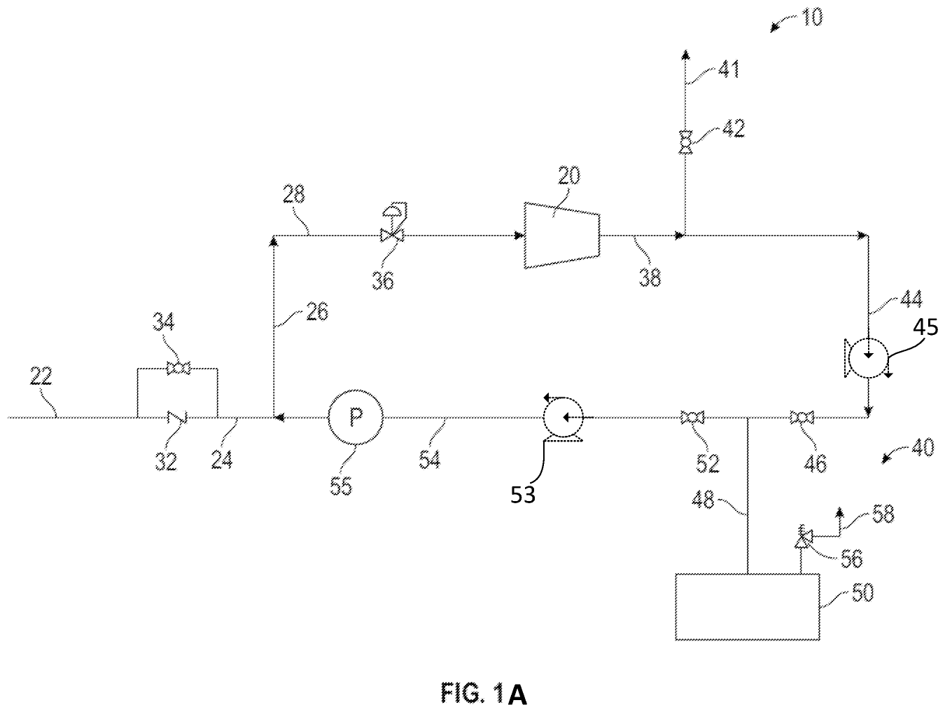

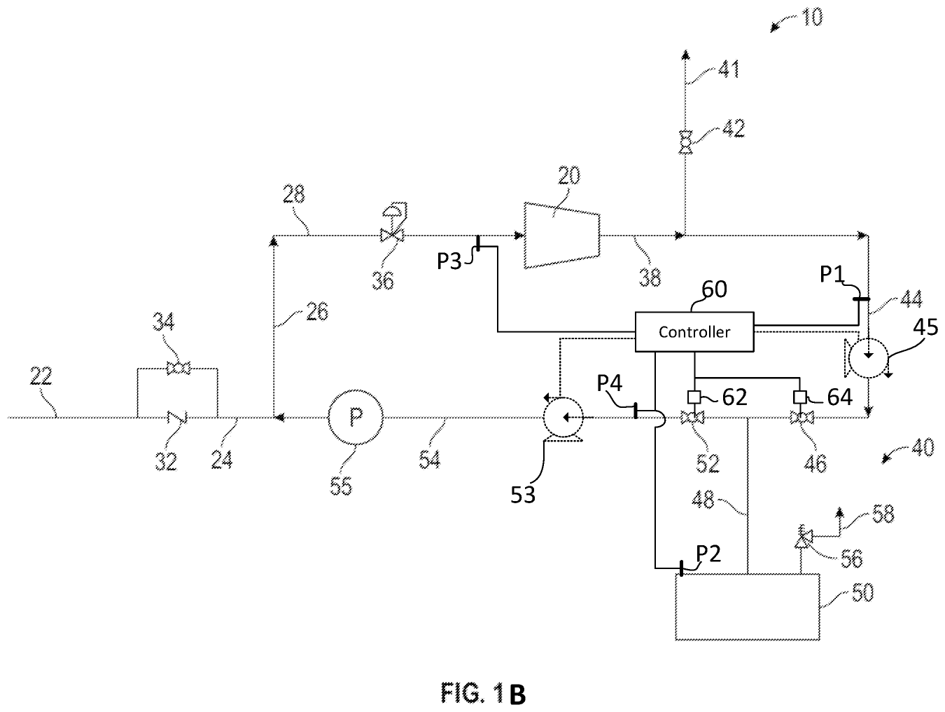

Referring to FIG. 1A, a natural gas compressor station 10 includes a compressor unit 20 connected for fluid communication with a methane retention system 40. During operation, the compressor unit 20 can receive natural gas from a source through a suction line 22 that can include a first suction line segment 24, which in turn feeds into a second suction line segment 26, which in turn feeds into a third suction line segment 28, which in turn feeds directly into the natural gas compressor unit 20. The first suction line segment 24 can be equipped with a check valve 32 connected in parallel with a ball valve 34 which can, in one embodiment, be a spring-type “dead man” ball valve. The second suction line segment 26 joins the first suction line segment 24 and the third suction line segment 28. The third suction line segment 28 is equipped with a suction control valve 36 that enables natural gas from the source to be pulled through the suction line segments 24, 26 and 28 with the aid of suction from the suction side of compressor unit 20, and fed into the natural gas compressor unit 20.

Natural gas compressor units are used in conjunction with pipelines to move natural gas over short or long distances. Natural gas compressor units work by mechanically increasing the gas pressure in stages or steps until the natural gas reaches a desired delivery point through a pipeline system. The pressure inside the compressor unit 20 will vary depending on the stage of compression, the size of the compressor unit 20 and the distance required for delivery. In one example of a three-stage reciprocating compressor, the natural gas might enter the inlet or “suction side” of the compressor unit at around 30 psi (two atmospheres) and ambient temperature. The first stage of compression might compress the natural gas to about 150 psi (ten atmospheres) and about 260° F. The second stage might increase the pressure to about 500 psi (34 atmospheres) and about 270° F. The third stage might further increase the pressure to about 1200 psi (82 atmospheres) and about 240° F. After each stage, the natural gas passes through a cooler and can be cooled to around 120° F. before entering the next stage. The natural gas compressor unit 20 illustrated in FIG. 1A can be representative of any natural gas compressor unit of any size, purpose and number of stages, because all such systems require depressurization and maintenance, and an objective of the present disclosure is to reduce the amount of natural gas that is vented into the atmosphere.

During operation, natural gas from the compressor unit 20 can exit into a natural gas pipeline (not shown) that carries the natural gas toward a desired destination. During a conventional (prior art) depressurizing operation for maintenance of the compressor unit 20, the suction control valve 36 is closed and natural gas can exit the compressor unit 20 through an exit line 38 that feeds directly into a blowdown line 41 equipped with a ball valve 42. When the ball valve 42 is open, the natural gas from the compressor unit 20 would thereby be vented directly into the atmosphere until the pressure inside the compressor unit 20 equilibrates with the surrounding atmosphere. In accordance with the present disclosure, the ball valve 42 remains closed and the natural gas from the compressor unit 20 instead passes from the exit line 38 into a recycle line 44 that carries the natural gas through an open recycle ball valve 46 and into the accumulator line 48, whereupon the natural gas vents into the at least one accumulator vessel 50. The venting continues as the natural gas pressure in the compressor unit 20 is lowered and the natural gas pressure in the accumulator vessel 50 is raised, until both pressures reach an equilibrium pressure. As explained above, the natural gas pressure in the compressor unit 20 can be minimized by selecting an accumulator vessel 50, or more than one accumulator vessel 50, having a total volume that is large relative to the volume of the compressor unit 20. The natural gas pressure in the compressor unit 20 can be lowered even further by employing an optional suction pump 45 or other suitable gas pump in the recycle line 44 or the accumulator line 48.

Once the natural gas pressure inside the compressor unit 20 has been minimized, the recycle ball valve 46 that regulates flow in the recycle line 44 can be closed to thereby isolate and temporarily store the vented natural gas in the accumulator vessel 50. During this entire venting operation, the return ball valve 52 located in the return line 54 connected to the accumulator line 48 can also remain closed in order to direct the flow of vented natural gas into the accumulator vessel 50. Once the accumulator vessel 50 has been isolated, any residual natural gas in the compressor unit 20 can then be vented and released into the atmosphere through the blowdown line 40 by opening the ball valve 42. Maintenance can then be performed on the compressor unit 20.

Once the maintenance on the compressor unit 20 has been completed, the compressor unit 20 can be restarted and the suction control valve 36 can be reopened to allow a new feed of natural gas from the source through the suction line 22. The return ball valve 52 located in the return line 54 can then be opened while the recycle ball valve 46 remains closed, allowing the natural gas in the at least one accumulator vessel 50 to flow through the return line 54 with the aid of suction control valve 36, whereupon the natural gas joins and mixes with new natural gas from the source in the second suction line segment 26 of suction line 22. A pressure regulator 55, which can be a pressure control valve, can also be included in the return line 54 to ensure that the natural gas from the accumulator vessel(s) 50 is fed at a controlled pressure so as not to overwhelm the compressor unit 20. Any residual natural gas that remains in the accumulator vessel(s) 50 can then be vented into the atmosphere by opening valve 56 in vent line 58. Alternatively, the natural from the accumulator vessel(s) can be more fully evacuated by employing an optional suction pump 53 or other suitable gas pump in the return line.

As will be apparent to persons of ordinary skill in the art, variations in the above description can be made to accommodate normal operational variations in natural gas compressor stations and the compressor units that are being used. If the compressor unit has three stages operating at different pressures, then all three stages can be vented into the recycle line 44 and the accumulator vessel(s) 50 either simultaneously or in steps. If, upon resuming operation, the pressure in the accumulator vessel is high relative to the desired natural gas pressure in the suction line 22, then a pressure regulator 55 may be placed in the return line 54 so that the natural gas in the accumulator vessel 50 can be gradually released, so as not to overwhelm the compressor unit 20. Depending on the size of the compressor unit and the layout of the plant, the methane retention system may include one very large accumulator vessel 50 whose volume is very large relative to the volume of the compressor unit 20, or may include a plurality of smaller vessels whose combined volume is very large relative to the volume in the compressor unit 20. Other variations from these embodiments will also be apparent to persons of ordinary skill in the art.

FIG. 1B illustrates another embodiment of a natural gas compressor station 10 including a compressor unit 20 connected for fluid communication with a methane retention system 40. The embodiment of FIG. 1B shares numerous components with the embodiment of FIG. 1A and the same reference numerals are utilized with common components of the embodiments. In the embodiment of FIG. 1B, a controller 60 monitors and controls the depressurization of the compressor unit 20, storage of natural gas in the methane retention system 40 and return of the natural gas to the compressor unit 20. As illustrated, the controller 60 is operatively connected to the recycle ball valve 46 and the return ball valve 52. More specifically, the controller 60 is operatively connected to actuators or solenoids 62, 64 attached to the valves 46, 52, respectively. The actuator/solenoids may be any appropriate mechanism (electric, pneumatic etc.) that allows the opening and closing of the valves in response to control outputs from the controller 60. For instance, a servo valve may be utilized to proportion flow through a given valve. The controller 60 may additionally be operatively connected to the suction control valve 36 on the inlet side of the compressor unit and/or the vent valve 42 on the outlet side of the compressor unit. The controller 60 is also connected a plurality of pressure sensors or transducers ‘P’ that may disposed within various system components. In an embodiment, a first pressure sensor P1 is disposed in the recycle line 44 and a second pressure sensor P2 is disposed in the accumulator vessel 50. In this embodiment, the first pressure sensor P1 may provide an output indicative of the pressure inside the compressor unit 20 (e.g., once the suction control valve is closed) and the second pressure sensor P2 may provide an output indicative of the pressure inside the accumulator vessel.

In operation, the controller may close the suction control valve 36, open the recycle valve 46 and close the return valve 52. The controller may monitor pressures in the recycle line (e.g., P1) and accumulator vessel (e.g., P2) to identify when the pressures equalize. At such time, the controller may close the recycle valve and open the vent valve 42. Alternatively, the controller 60 may, once pressure in the recycle line reaches a predetermined threshold, operate the pump 45 until pressure in the compressor unit/recycle line 44 reaches atmospheric pressure. At such time, the compressor may close the recycle valve 52 and discontinue operation of the pump 45. Though discussed as having first and second pressure sensors, it will be appreciated that additional pressure sensors may be incorporated. For instance, a pressure sensor P3 may be placed on the inlet side of the compressor unit and/or a pressure sensor P4 may be placed in the recycle line 54. In an embodiment, the pressure sensor P3 on the compressor unit inlet and pressure sensor P4 may be utilized to control the return of the natural gas to the compressor unit. In an embodiment, the depressurization may be an automated process. Likewise, once any necessary maintenance is performed on the compressor unit, the return of the natural gas may be an automated process.

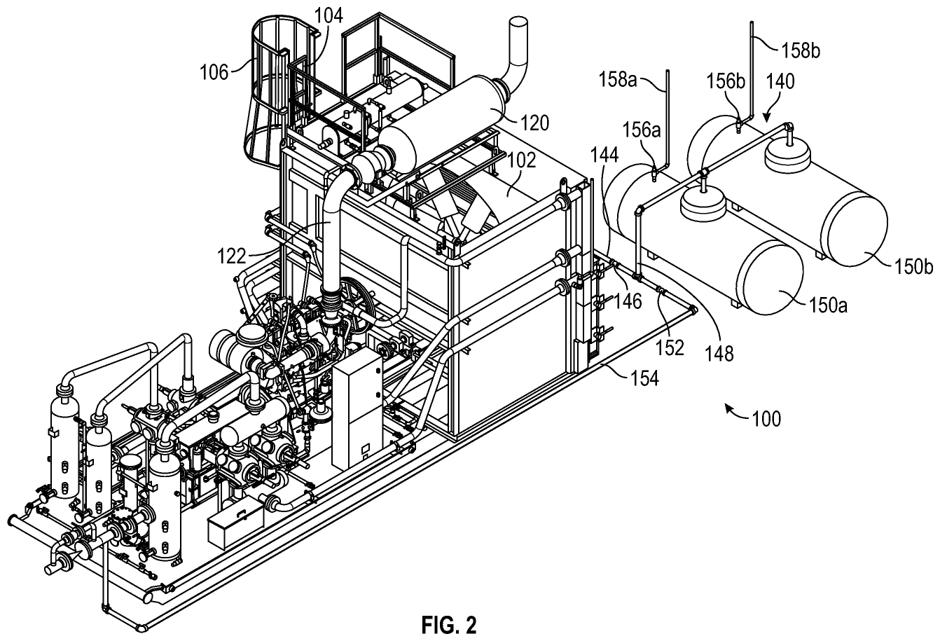

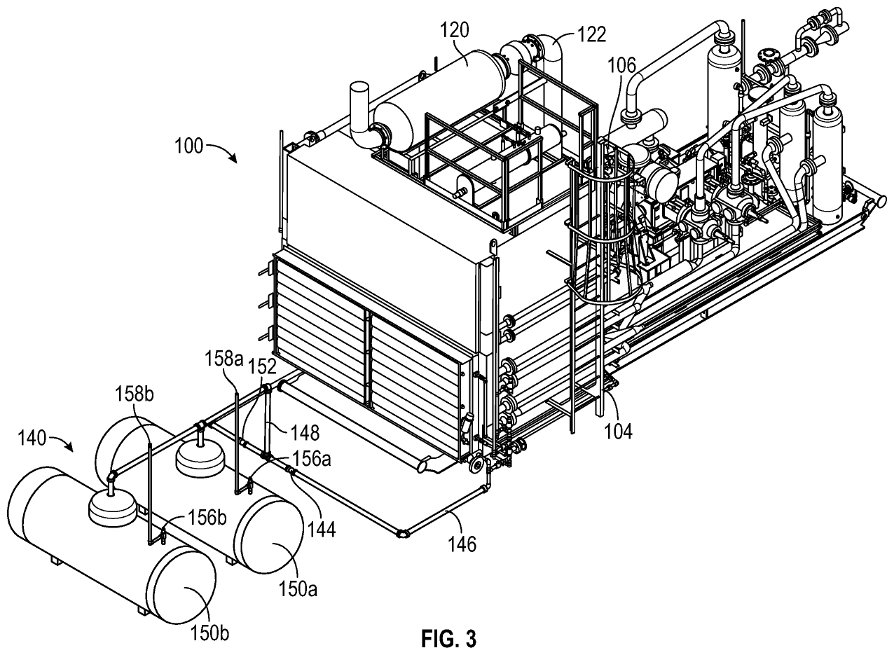

FIGS. 2 and 3 are opposing perspective views of an exemplary natural gas compressor station 100 that can be equipped with a methane retention system in accordance with the present disclosure. Because many of the illustrated features are conventional and known to persons or ordinary skill in the art, only the pertinent features will be further described. Natural gas compressor station 100 includes a natural gas compressor unit 120 positioned on an elevated platform 102. The platform 102 is equipped with ladder 104 and elevator 106 which permits access for maintenance. The station is equipped with a methane retention system 140 that includes two large accumulator vessels 150a and 150b, thereby providing a total accumulator vessel volume that is at least five times larger than the volume of the natural gas compressor unit 120. During normal operation, natural gas is fed to the compressor unit 120 via suction line 122 which, as shown, includes a plurality of suction line segments. When the compressor unit 120 requires maintenance, the suction line 122 is isolated from the compressor unit to enable the compressor unit to be depressurized and maintained. The residual natural gas in the compressor unit 120 is vented into the accumulator vessels 150a and 150b using the recycle line 144 which feeds the natural gas through the open recycle valve 146 and into the accumulator line 148. When the pressure inside the accumulator vessels 150a and 150b equilibrates with the residual pressure in the compressor unit 120, the recycle valve 146 is closed to isolate the vented natural gas in the accumulator vessels from the compressor unit 120. During this time, the return valve 152 in the return line 154 remains closed and any residual natural gas in the compressor unit 120 is vented into the atmosphere. When the maintenance has been completed and the compressor unit 120 is restarted, the return valve 152 is opened and the natural gas from the accumulator vessels 150a and 150b is released into the return line 154, whereupon the natural gas from the accumulators joins the natural gas being fed from the illustrated piping network to the suction line 122 and is recycled back into the compressor unit 120. Any residual natural gas in the accumulator vessels 150a and 150b can them be vented into the atmosphere by opening the valves 156 in the vent lines 158.

The present disclosure thus provides a methane retention system, a method of depressurizing a natural gas compressor unit, and an overall natural gas compressor system that includes the methane retention system, where the foregoing method can be practiced. The amount of natural gas that is released into the atmosphere can thereby be reduced by a least about 65 percent, or at least about 75 percent, or at least about 85 percent, or at least about 90 percent, or at least about 95 percent compared to a natural gas compressor station that does not include the methane retention system. Stated from another perspective, when the natural gas compressor unit is decompressed according to the method described herein, less than about 35 percent, or less than about 25 percent, or less than about 15 percent, or less than about 10 percent, or less than about 5 percent of the residual natural gas in the compressor unit will be released into the atmosphere.

1. A methane retention system for receiving, storing, and recycling vented natural gas from
a natural gas compressor unit, comprising:
at least one accumulator vessel;
at least one recycle line in fluid communication with the compressor unit and the accumulator vessel;
at least one return line in fluid communication with the accumulator vessel and an inlet to the compressor unit;
at least one recycle line valve in the recycle line; and
at least one return line valve in the return line;
wherein the methane retention system is configured to receive natural gas from the compressor unit, store the natural gas in the accumulator vessel, and subsequently return the natural gas to the compressor unit.

2. The methane retention system of claim 1, comprising two or more of the accumulator vessels.

3. The methane retention system of claim 1, further comprising a gas pump disposed within the recycle line, wherein the gas pump is configured to draw gas from the compressor unit and output the natural gas to the accumulator vessel.

4. The methane retention system of claim 1, wherein the at least one accumulator vessel has a volume of at least about 250 scf.

5. The methane retention system of claim 1, wherein the at least one accumulator vessel has a volume of at least about 500 scf.

6. The methane retention system of claim 1, further comprising a pressure regulator in the return line.

7. The methane retention system of claim 1, further comprising a gas pump disposed within the return line, wherein the gas pump is configured to draw gas from the accumulator vessel and output the natural gas to the inlet of the compressor unit.

8. The methane retention system of claim 1, further comprising a controller operative to open and close the recycle line valve and the return line valve.

9. The methane retention system of claim 8, wherein the controller operates the recycle line valve and the return line valve based on monitored pressures in at least one of the compressor unit and the accumulator vessel.

10. A method of decompressing a compressor unit, comprising the steps of:
isolating the compressor unit from a source of natural gas;
placing an outlet of the compressor unit in fluid communication with at least one accumulator vessel;
releasing natural gas from the compressor unit into the at least one accumulator vessel in fluid communication with the compressor unit until a first pressure inside the compressor unit is lowered to a desired second pressure; and
isolating the accumulator vessel from the compressor unit to temporarily store the natural gas vented from the compressor unit.

11. The method of claim 10, wherein the second pressure is approximately equal to a pressure inside the at least one accumulator vessel.

12. The method of claim 10, wherein the second pressure is less than a pressure inside the at least one accumulator vessel.

13. The method of claim 12, further comprising pumping the natural gas from the compressor unit to the accumulator vessel.

14. The method of claim 10, further comprising the step of venting any remaining natural gas from the compressor unit into an atmosphere after the accumulator vessel has been isolated.

15. The method of claim 10, further comprising the step of feeding natural gas from the at least one accumulator vessel back into the compressor unit at a desired time.

16. The method of claim 15, further comprising the step of regulating the pressure of the natural gas from the accumulator vessel as it is being fed back into the compressor unit.

17. The method of claim 10, wherein the compressor unit comprises multiple stages and natural gas from the multiple stages is released simultaneously into the accumulator vessel.

18. The method of claim 10, wherein the compressor unit comprises multiple stages and natural gas from the multiple stages is released in steps into the accumulator vessel.

19. A natural gas system, comprising:
a compressor unit; and
a methane retention system connected to the compressor unit;
wherein the methane retention system is configured to accept and store natural gas from the compressor unit during depressurization of the compressor unit so that less than about 35% of the natural gas in the compressor unit is released into an atmosphere during depressurization of the compressor unit.

20. The natural gas system of claim 19, wherein the methane retention system is configured so that less than about 15% of the natural gas in the compressor unit is released into an atmosphere during depressurization of the compressor unit.

21. The natural gas system of claim 19, wherein the methane retention system comprises at least one accumulator vessel in fluid communication with the compressor unit.

22. The natural gas system of claim 21, wherein the at least one accumulator vessel is in fluid communication with the compressor unit via at least one recycle line and at least one return line.

23. The natural gas system of claim 21, wherein the accumulator vessel has a volume that is at least four times a volume of the compressor unit.

24. The natural gas system of claim 22, further comprising a gas pump in the recycle line.

25. The natural gas system of claim 22, further comprising a pressure regulator in the return line.
